(19) United States
(12) Patent Application Publication
(10) Pub. No.: US 2020/0324613 A1
(43) Pub. Date: Oct. 15, 2020

(54) METHOD, SYSTEM, AND APPARATUS FOR INTERACTIVE CLIMATE CONTROL

(71) Applicant: NIO USA, Inc., San Jose, CA (US)

(72) Inventors: Pierluigi Dalla Rosa, Oakland, CA (US); Daniel Paul Nacamuli, San Francisco, CA (US); Timothy J. Meador, Fairfield, CA (US); Qianqian Ye, San Francisco, CA (US); Nicholas D. Hoppesch, Daly City, CA (US); Meera Ramachandran, San Francisco, CA (US); Zachury B. Minjack, San Francisco, CA (US); Robin Bigio, San Francisco, CA (US); Alex E. Alvarez Castellarnau, Menlo Park, CA (US)

(21) Appl. No.: 16/378,831

(22) Filed: Apr. 9, 2019

(51) Int. Cl. B60H 1/00

(52) U.S. Cl. CPC B60H 1/0065; B60H 1/00771; B60H 1/00742; B60H 1/00821

(57) ABSTRACT

A vehicle comprising a Heating, Ventilation, and Air-Conditioning (HVAC) control assembly for navigating a menu associated with an HVAC system of the vehicle, the menu controlling operation of the HVAC system. A multiple input tactile control device, interface, and system is provided. In addition to providing input by rotating the tactile control device, a user can provide input via touching a touchpad, actuating the touchpad, and/or actuating the tactile control dial in the linear axial direction.

### FIELD

The present disclosure is generally directed to user interface devices, in particular, toward multiple-input user interface devices for Heating, Ventilation, and Air-Conditioning (HVAC) control in vehicles.

### BACKGROUND

Navigating complex user interfaces in a computing environment typically requires a combination of several different input devices that are each configured to provide a specific type of output. While a keyboard can be used to enter text or other characters, a mouse, stylus, or touchscreen input may be required to point a cursor and/or select an interface element rendered by a display device. These traditional interface devices, however, may not be feasible to use when interacting with the complex computing interfaces and display devices associated with a vehicle. In another example, the traditional HVAC controls in vehicles comprise multiple knobs and/or buttons to control the different functions, such as: fan speed, airflow direction, temperature, mode, etc.

Among other things, some vehicles, such as autonomous and/or electric vehicles may have limited console space to house the multiple knobs and buttons used in traditional HVAC control systems. Additionally, fewer knobs and/or buttons creates a more streamlined and less cluttered console.

### BRIEF DESCRIPTION OF THE DRAWINGS

FIG. 1 illustrates a vehicle interior environment in accordance with embodiments of the present disclosure;

FIG. 2 illustrates an HVAC input control system in accordance with embodiments of the present disclosure;

FIG. 3 illustrates an operation of the HVAC input control system to adjust the set temperature in accordance with embodiments of the present disclosure;

FIG. 4 illustrates an operation of the HVAC input control system to select an airflow direction in accordance with embodiments of the present disclosure;

FIG. 5 illustrates a tilt operation of the HVAC input control system to adjust the fan speed in accordance with embodiments of the present disclosure;

FIG. 6 illustrates an alternate tilt operation of the HVAC input control system in accordance with embodiments of the present disclosure;

FIG. 7 illustrates an operation of the HVAC input control system in accordance with embodiments of the present disclosure;

FIG. 8 illustrates an operation of the HVAC input control system in accordance with embodiments of the present disclosure;

FIG. 9 illustrates an operation of the HVAC input control system in accordance with embodiments of the present disclosure;

FIG. 10 is a block diagram of the hardware of a user interface system in accordance with embodiments of the present disclosure;

FIG. 11 is a block diagram of a computing environment associated with the embodiments presented herein;

FIG. 12 is a block diagram of a computing device associated with one or more components described herein;

FIGS. 13-14 illustrate an example of a climate control interface in accordance with embodiments of the present disclosure;

FIG. 15 illustrates various states of a temperature indicator in accordance with embodiments of the present disclosure;

FIG. 16 illustrates an example of the user adjusting the temperature in accordance with embodiments of the present disclosure;

FIG. 17 illustrates an example of a temperature indicator, where the temperature adjustment is illustrated with an animated temperature indicator in accordance with embodiments of the present disclosure;

FIG. 18 illustrates an example of a climate control interface with automode is activated in accordance with embodiments of the present disclosure;

FIG. 19 is a flow diagram of a method for activating automode in accordance with embodiments of the present disclosure; and

FIG. 20 illustrates an example of selecting ambient mode in accordance with embodiments of the present disclosure.

### DETAILED DESCRIPTION

In some embodiments, the present disclosure describes a Heating, Ventilation, and Air-Conditioning (HVAC) control assembly for, among other things, navigating a menu associated with an HVAC system of a vehicle. The HVAC control assembly provides a single input system for navigating various menus and controlling multiple functions associated with the vehicle's HVAC system in an efficient and simple manner. The device may be a user input device for a vehicle configured with a tactile control, such as a moveable dial, joystick, or tactile control dial. The tactile control dial may be configured to rotate and move in a linear direction along a length of the axis. Additionally, the dial may be able to tilt (e.g., up, down, left, right, etc.). In some embodiments, the tactile control dial may include an optical encoder with integrated joystick and pushbutton similar to the series 60AD optical encoder with integrated joystick and pushbutton manufactured by Grayhill, Inc.

The HVAC control assembly may also include a climate control interface that displays the various HVAC settings. Traditionally, a user needs to look down or away from the road in order to adjust the HVAC settings. In some embodiments, the climate control interface may be positioned to allow the driver to keep her eyes on the road while adjusting the HVAC settings. In some examples, the climate control interface display is included in the vehicle's instrument cluster, digital instrument panel or digital dash cluster. In other words, the climate control interface is placed such that the driver would not need to look down and away from the road to make adjustments to the HVAC system. Advantageously, the HVAC controller is streamlined to use multiple degrees of freedom, thereby minimizing the footprint while offering flexible and individual control to each occupant. The other major advantage is the ability to decouple the user interface from the HVAC controller allowing the controller to be within arm's reach of the occupant while the user interface can be in a place that reduces driver distraction.

In some embodiments, the HVAC control input system may be positioned in the door assembly, with each passenger having their own input system, including a dial and one or more buttons, to control the HVAC system. For example, two-door vehicles, have separate input systems for the driver and passenger and vehicles with four-doors, may have separate input systems on each door. In addition to separate input systems, each input system may have a separate corresponding display interface. In other examples, the driver and passenger may share the same climate control interface. Whether the climate control interface is individual or shared, it may be located in the dash assembly of the vehicle. Some embodiments may also include a control for the rear seat, or even separate controls for each rear seat passenger, including corresponding displays.

In some cases, the HVAC control assembly may also include a touch-based, touch sensitive interface, or touchpad. In some embodiments, the touch sensitive interface may be disposed surrounding the dial. In one embodiment, the touchpad may be rotationally fixed, but may be configured to move in the linear direction along the rotational axis along with or independently of the dial. Some embodiments may not require this touchpad. However, the touchpad may allow for multi-touch input provided by a user. The touchpad may be covered by a touchpad cover and may be placed on top of a trackpad holder. In one embodiment, the touchpad may be affixed, or otherwise attached, to a rotationally fixed shaft of the tactile control dial user interface device.

The tactile control dial and/or the touchpad may be actuated, or depressed, in a direction along this input line of travel to provide an input to the vehicle's HVAC system. For example, depressing/actuating the tactile control dial may open an HVAC menu to be displayed in the climate control interface. In some embodiments, the main HVAC interface comprising temperature information is persistently displayed in the cluster. When the user depresses the main controller of the HVAC input system, a menu for airflow direction is displayed the menu, from which the user may select a different airflow configuration. In some embodiments, the user may also navigate to other menus to control temperature, airflow speed and/or, A/C.

The software and processing system of the HVAC control assembly may interpret the movement characteristics of the tactile control dial to determine an input command to control an aspect of the HVAC system. In other words, the HVAC control assembly maps HVAC functions to HVAC input system control with increased inputs. That is to say, depending on the active menu the same input may be interpreted as different controls. For example, if the temperature menu is active, rotating the tactile control dial increases/decreases the set temperature. However, when the mode menu is active, then rotating the tactile control dial selects the various modes. The processing system may further generate a corresponding control signal to the HVAC system. The relationship between the tactile control dial's movement properties may provide different visual effects based on a context of the elements displayed in the climate control interface.

With the HVAC control assembly described herein it is possible to control multiple HVAC settings with a single input device. Accordingly, the number of controls (e.g., knobs, buttons, etc.) may be reduced, and positioned on the door of the vehicle, streamlining the vehicle's cab making the vehicle's less cluttered and reducing the amount of space needed to house the HVAC controls.

Embodiments of the present disclosure will be described in connection with a computing system and/or display devices of a vehicle, and in some embodiments, an electric vehicle, rechargeable electric vehicle, and/or hybrid-electric vehicle and associated systems. It should be appreciated, however, that the tactile control dial user interface device is not limited to use with a vehicle and may be used with any computing environment and/or display device.

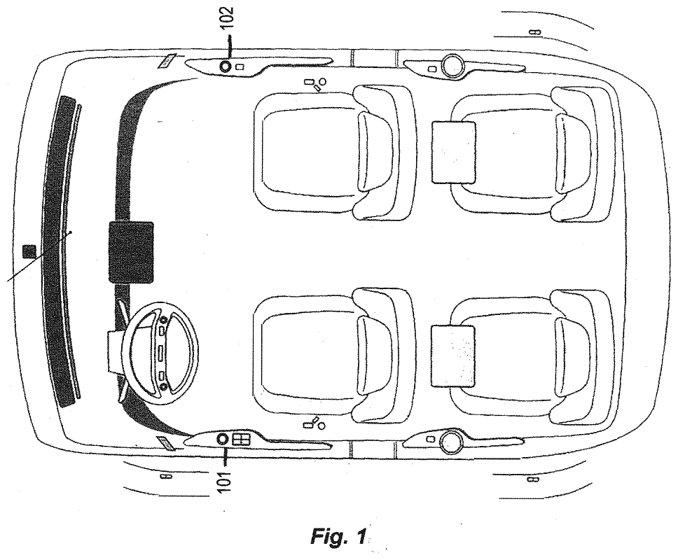

FIG. 1 illustrates an interior view of a vehicle environment in accordance with embodiments of the present disclosure. HVAC input control systems 101-102 of the HVAC control assembly are illustrated to be included in the door assembly of the vehicle, however alternate placement is possible. As illustrated, input control system 101 is located on the driver side door assembly and input control system 102 is located on the passenger side door assembly. In some embodiments, the HVAC input control system may be contained in the center console. Although not illustrated, the HVAC control assembly additionally includes a climate control interface or display, located in or near the vehicle's gauge cluster. In some embodiments, the display may be separated by one or more physical or virtual dividers, sections, areas, and/or zones of display. For example, one section may display a climate control interface, another section displays speed/RPM information, another section displays a map/navigation, and another section displays entertainment (e.g., radio) information. The display may be configured to render visible objects (e.g., icons, menus, maps, lists, images, moving images, videos, interactive presentations, vehicle information/indicators, etc.) via a display (e.g., by selectively providing power and/or communications signals to pixels and/or other display elements of the display device, etc.). The vehicle interior environment may be associated with an interior of a vehicle; however, it should be appreciated embodiments of the present disclosure are not so limited.

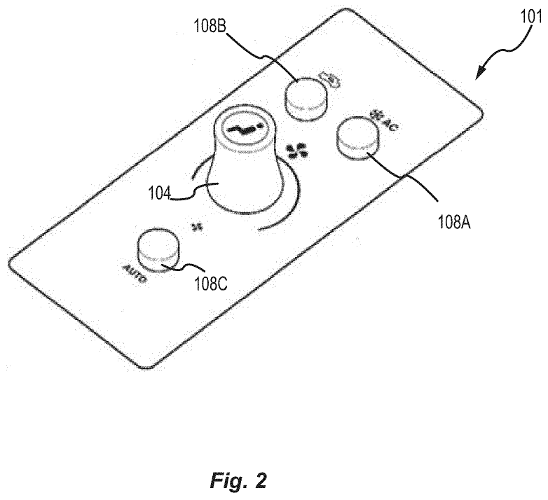

FIG. 2 illustrates a more detailed view of HVAC control assembly, not shown for clarity is the climate control interface portion. The input control portion 101 of HVAC control assembly 101 includes dial 104 and buttons 108A-C. Button 108A activates the vehicle's A/C, button 108B activates re-circulation, and button 108C activates automode. Although, in some embodiments, these functions may be controlled via tactile control dial device 104. The hardware buttons 108 may be configured as switches, buttons, dials, touchpads (e.g., capacitive and/or resistive touch-sensitive pads), and/or some other control device for use in connection with certain control operations of the vehicle's HVAC system and/or the tactile control dial device 104. In some embodiments, additional features, such as heated seats, defrost, air conditioning, and air recirculation, may be controlled using tactile control dial device 104. In other words, different operations may be mapped to the different tilt directions. For example, tilting dial device 104 down may activate the heated seats control. In another example, tilting tactile control dial 104 to up may activate the defrost (front, rear, and/or front and rear. Controls for air conditioning and recirculation, mapped to hardware buttons 108 may also be incorporated into tactile control dial 104. For example, tilting dial 104 to the right may activate the air conditioning. In yet another example, tilting dial device 104 to the left may activate the air recirculation feature. In some embodiments, tactile control dial 104 includes tilt directions in addition to up, down, left, and right. For example, if the up tilt direction comprises zero degrees, the tilt directions could comprise, zero (0°), forty-five (45°), ninety (90°), one-eighty (180°), two-twenty-five (225°), and two-seventy (270°). In other embodiments, tactile control dial device 104 may allow to scroll through an HVAC menu, and press down to select an operation, accessing a sub-menu.

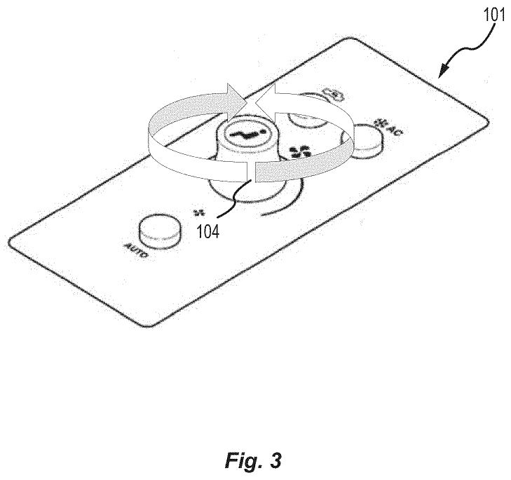

FIG. 3 illustrate an operation of input control portion 101 to adjust the temperature in accordance with embodiments disclosed herein. The user may rotate dial 104 both clockwise and counter-clockwise. In some embodiments, when the climate control interface is in the main display, and/or displaying the set temperature for the HVAC system, the user may rotate dial 104 clockwise to increase the set temperature and rotate dial 104 counter-clockwise to decrease the set temperature.

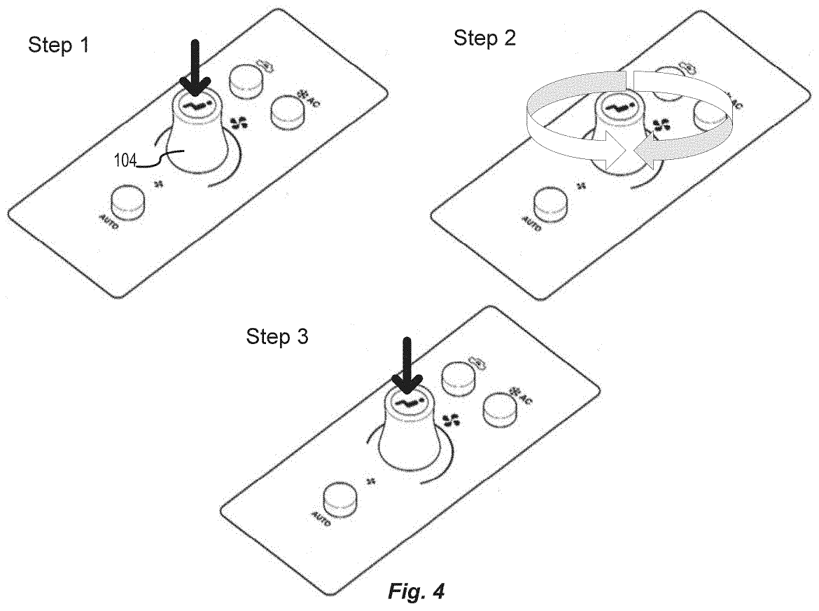

FIG. 4 illustrates another operation of input control portion 101 to adjust the direction of airflow (e.g., mode) in accordance with embodiments disclosed herein. From the main display, the user may first depress dial 104 to activate the mode menu (step 1). In some embodiments, input control portion 101 may include lighted icons in order to further indicate which function is active. For example, when the airflow direction/mode function activated, the “modeman” icon in the center of dial 104 may illuminate. After the mode menu is activated, the user may rotate dial 104 to select a different mode (step 2). Dial 104 may rotate clockwise and counter-clockwise. As the user rotates dial 104 the climate control interface display switches between the various modes (e.g., upper, lower, upper and lower, etc.). In some embodiments, once the desired mode is selected, the user may depress dial 104 again to activate the selected mode (step 3). Once the selected mode is activated, the display may return to the main display/menu and the “modeman” icon may no longer be illuminated. If the menu returns to the temperature function, the temperature indicator may illuminate.

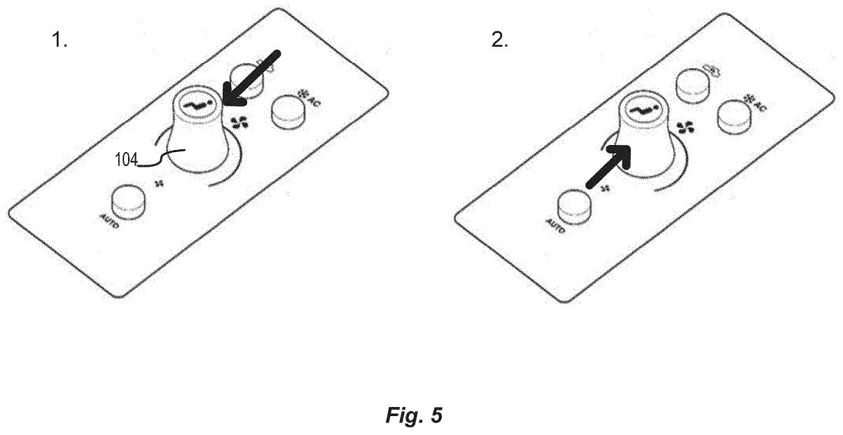

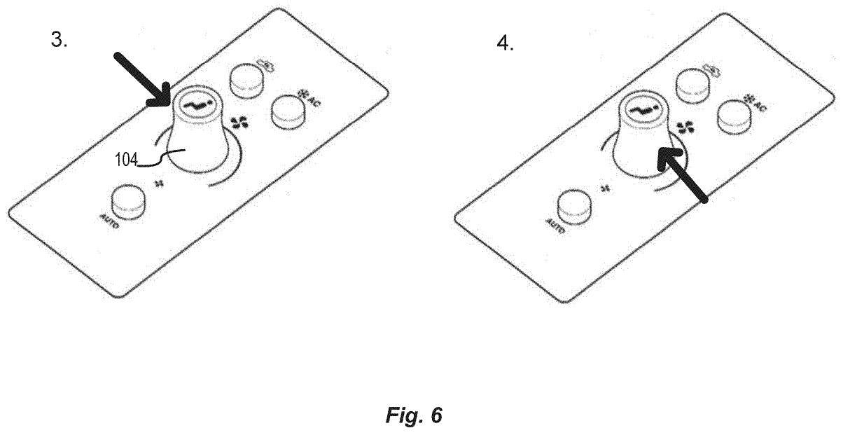

FIG. 5 illustrate a tilt operation of input control portion 101 to adjust the fan speed in accordance with embodiments disclosed herein. The user may tilt dial 104 down (1) to decrease the fan speed or tilt tactile control dial 104 up (2) to increase the fan speed. In some embodiments, input control portion 101 may include lighted icons in order to indicate which function is active. For example, if the fan speed function is active, then the fan icon may be lighted or otherwise indicate its active status. FIG. 6 illustrates an alternate tilt operation of dial 104. The user may tilt dial 104 right (3) and/or left (4).

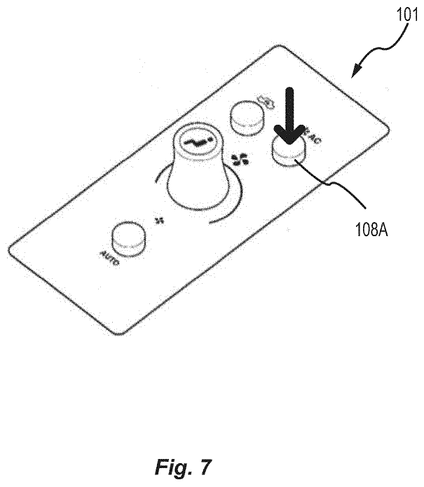

FIGS. 7-9 illustrate various operations of input control portion 101, when buttons 108A-C are depressed in order to activate their associated function. In this example, button 108A activates the vehicle's A/C, button 108B activates re-circulation, and button 108C activates automode.

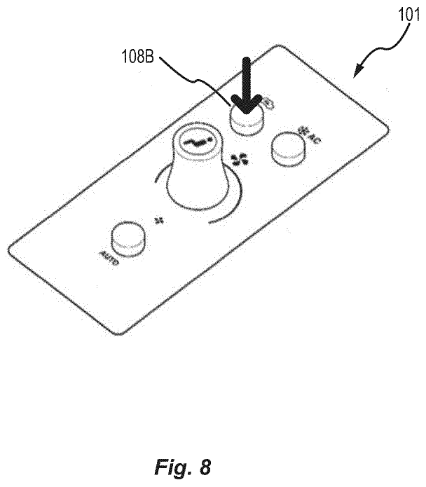

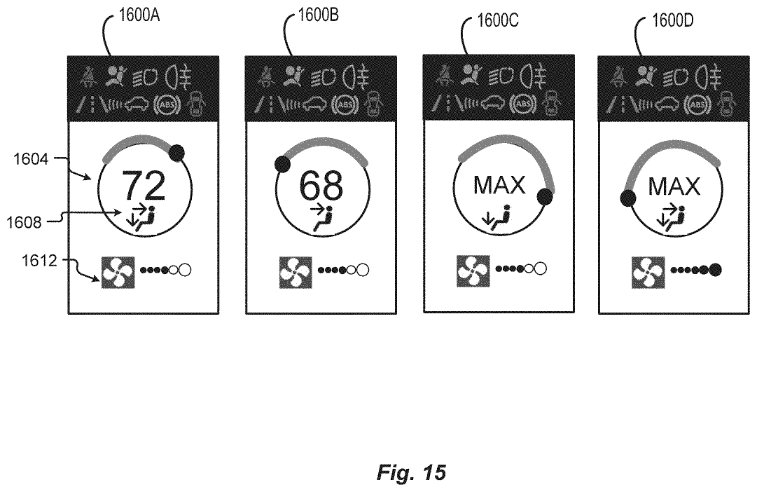

FIG. 8 shows a perspective view of an interior vehicle environment 100 in accordance with embodiments of the present disclosure. In some embodiments, the HVAC control/input system may be located in the center console as illustrated. The HVAC input system may be configured to include a tactile control dial 104, at least one display device 112, and/or physical interface hardware buttons 108. In some embodiments, the climate control interface portion (further illustrated in FIGS. 15A-B, 16, 17A-B, 18, and 20) is included in display device 112.

In some embodiments, the display device 112 may be separated by one or more physical or virtual dividers, sections, areas, and/or zones of display. For example, one section may display a climate control interface, another section displays a map/navigation, and another section displays audio (e.g., radio) information. The display device 112 may be configured to render visible objects (e.g., icons, menus, maps, lists, images, moving images, videos, interactive presentations, vehicle information/indicators, etc.) via a display (e.g., by selectively providing power and/or communications signals to pixels and/or other display elements of the display device, etc.). The vehicle interior environment 100 may be associated with an interior of a vehicle, however, it should be appreciated embodiments of the present disclosure are not so limited. In the case of a vehicle interior, the tactile control dial 104 may be mounted to, or at least partially within, a portion of the vehicle such as an arm rest, center console or dash panel 116, seat, steering wheel, or another surface inside the vehicle interior.

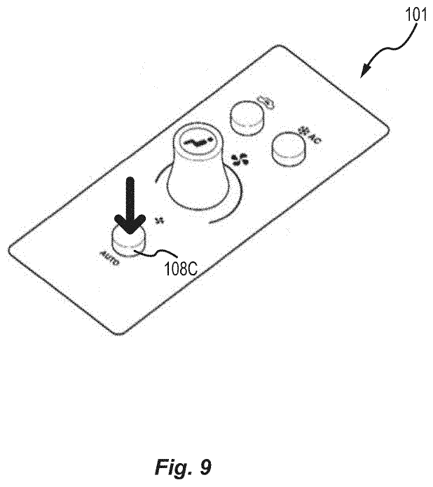

FIG. 9 is a block diagram of the hardware of a HVAC control assembly system 200 in accordance with embodiments of the present disclosure. As described above, the HVAC control assembly system 200 may include one or more display devices 112 that are configured to selectively activate pixels and/or display elements to render one or more user interface windows, indicators, icons, characters, menus, etc. In one embodiment, the display device 112 may be a liquid crystal display (LCD), a light-emitting diode (LED) display, electroluminescent display (ELD), organic LED (OLED) display, and/or some other two-dimensional and/or three-dimensional display device. In some embodiments, the display device 112 may extends along a length of a vehicle console or dash. The display device 112 may be configured to render vehicle HVAC information in one or more discrete areas of the display 256. In any event, the display device 112 may include a power supply 240, a signal receiver 244, a display driver 248, at least one input/output port 252, a display 256, and/or more 258.

One or more display controllers 236 may be included for controlling the operation of the display device 112, including input (e.g., tactile control dial device input) and output (display) functions. In some embodiments, the functions of the display controller 236 may be incorporated into other components, such as a processor or computer system 232.

The computer system 232 may include a processor or controller for executing application programming and/or instructions. In accordance with at least some embodiments of the present disclosure, the computer system 232 may include multiple processor cores, and/or implement multiple virtual processors. In one embodiment, the computer system 232 may include multiple physical processors. For instance, the computer system 232 may comprise a specially configured application specific integrated circuit (ASIC) or other integrated circuit, a digital signal processor, a controller, a hardwired electronic or logic circuit, a programmable logic device or gate array, a special purpose computer, and/or the like. The computer system 232 may function to run programming code or instructions implementing various functions of the HVAC control assembly system 200.

One or more hardware buttons 108 may be associated with the HVAC control assembly system 200 and/or the tactile control dial device 104. The hardware buttons 108 may be configured as switches, buttons, dials, touchpads (e.g., capacitive and/or resistive touch-sensitive pads), and/or some other control device for use in connection with certain control operations of the computer system 232 and/or the tactile control dial device 104. In some embodiments, hardware buttons 108 may comprise buttons to activate recirculation mode, A/C mode, and auto mode. Although, these functions may be controlled via tactile control dial device 104.

Communications between various components of the HVAC control assembly system 200 may be carried by one or more buses 202. In some embodiments, power may be supplied to the components of the HVAC control assembly system 200 from a power source and/or power control module. The power control module may include, but is in no way limited to, a battery, an AC-to-DC converter, power control logic, and/or ports for interconnecting the tactile control dial device 104, the display device 112, and/or other components of the HVAC control system 200 to a source of power.

The tactile control dial device 104 may include one or more processors 204, data storage 208, memory 212, position sensor(s) 216, touch sensitive input device 220, input switch(es) 224, haptic device(s) 228, and/or other components 232. As described herein, input provided by the tactile control dial device 104 may be communicated to the computer system 232 and/or the display device 112 via one or more bus 202.

The processor 204 may comprise a programmable processor or controller for executing application programming or instructions associated with the tactile control dial device 104. In some embodiments, the processor 204 may include multiple processor cores, and/or implement multiple virtual processors. In one embodiment, the processor 204 may include multiple physical processors. For instance, the processor 204 may comprise a specially configured application specific integrated circuit (ASIC) or other integrated circuit, a digital signal processor, a controller, a hardwired electronic or logic circuit, a programmable logic device or gate array, a special purpose computer, or the like. In any event, the processor 204 may function to run programming code or instructions implementing various functions of the tactile control dial device 104 and/or the HVAC control system 200.

The tactile control dial device 104 may also include a data storage 208 and/or memory 212 for use in connection with the execution of application programming or instructions by the processor 204, and/or for the temporary or long-term storage of program instructions and/or data. By way of example, the data storage 208 and/or the memory 212 may comprise RAM, DRAM, SDRAM, or other solid-state memory device. In one embodiment, the data storage 208 may comprise a hard disk drive or other random-access memory that is separate from the memory 212.

In some embodiments, the tactile control dial device 104 may include one or more position sensor(s) 216. The position sensor(s) 216 may provide a signal indicating a position of a code wheel, encoder plate, and/or rotary dial of the tactile control dial device 104. In one embodiment, this signal and position information can be provided as an input, for example to a user interface application running via the processor 204 and/or the computer system 232, to determine an HVAC operating mode, an output for display by the display device 112 (e.g., a position of a temperature indicator, mode indicator, fan speed indicator, etc., rendered by the display 256 of the display device 112), and/or other tactile control dial device 104 operations.

The position sensor(s) 216 may include one or more of a multiple position switch, an optical switch, an optical sensor (e.g., encoder, etc.), a magnetic sensor, a magnetic switch, a potentiometer, and/or other device capable of providing a signal indicating a number of multiple relative positions of the rotary dial from a rotational origin or reference point. In some embodiments, the tactile control dial device 104 is connected to an actuator, such as a stepper motor, wherein the steps may be associated with a number of degrees.

The tactile control dial device 104 may include at least one touch sensitive input device 220. In some embodiments, the touch sensitive input device 220 may be disposed inside a rotary dial and may be rotationally fixed (e.g., relative to the rotary dial etc.). The touch sensitive input device 220 may include a physical structure, or a touchpad substrate, that enables the user to interact with the computer system 232 by touching areas on the touchpad and provide information to a user through the display device 112. The touch sensitive input device 220 may sense user contact in a number of different ways, such as by a change in an electrical parameter (e.g., resistance or capacitance), acoustic wave variations, infrared radiation proximity detection, light variation detection, and/or the like.

In a resistive touchpad, for example, normally separated conductive and resistive metallic layers in the substrate pass an electrical current. When a user touches the touchpad, the two layers may make contact in the contacted location, whereby a change in electrical field is noted and the coordinates of the contacted location is calculated. In a capacitive touchpad, a capacitive layer may store electrical charge, which is then discharged to the user upon contact with the touchpad, causing a decrease in the charge of the capacitive layer. The decrease may be measured (e.g., via the processor 204, etc.), and the contacted location coordinates determined. In a surface acoustic wave touchpad, an acoustic wave is transmitted through the touchpad, and the acoustic wave may be disturbed by user contact/interaction. A receiving transducer can detect this user contact/interaction instance and then determine the contacted location coordinates associated with the contact/interaction.

Similar to the hardware buttons 108, the tactile control dial device 104 may include one or more integrated input switch(es) 224. These input switch(es) 224 may receive an actuation or selection input provided by a user at the one or more components of the tactile control dial device 104. In one embodiment, a user may press and physically displace (e.g., some distance) the rotary dial and/or touchpad along a common selection axis (e.g., the axis of rotation for the rotary dial, etc.) to provide a selection input. Additionally, a user may tilt (i.e. up, down, left, right, at an angle) the tactile control dial 104. This input may be received via a switch, button, optical sensor, or other device that is operatively coupled with the rotary dial and/or touchpad. In some embodiments, the rotary dial may be physically actuated separately and apart from physically actuating the touchpad, and/or vice versa. In this instance, separate input switch(es) 224 may be associated with each of the rotary dial and the touchpad (e.g., providing unique selection input for each device component).

In some embodiments, the tactile control dial device 104 may include one or more haptic device(s) 228. Haptic devices 228 can include any device that is configured to convert an electrical signal into a mechanical movement or physical feedback to a user of the tactile control dial user interface device 104. Examples of the haptic device(s) 228 may include, but are in no way limited to, vibrating motors, tactile transducers, eccentric movement motors, magnetically-actuated vibration devices, solenoids, vibrating motor disks, coin-cell vibration motors, piezoelectric transducers, surface transducers, and/or the like. As described herein, the haptic device(s) 228 may be configured to provide feedback to a user of a position of the rotary dial, a selection, a display output, a speed of output, and/or the like. In some embodiments, the feedback may be accompanied by an audible output (e.g., a sound, tone, click, etc.) provided by the haptic device(s) 228. In one embodiment, the haptic device(s) 228 may operate in conjunction with a speaker and/or an amplifier that provides the audible output. The haptic device(s) 228 may be attached to the touch sensitive input device 220, or touchpad, touchpad support member, the center shaft, the tactile control dial, or other surface of the tactile control dial device 104.

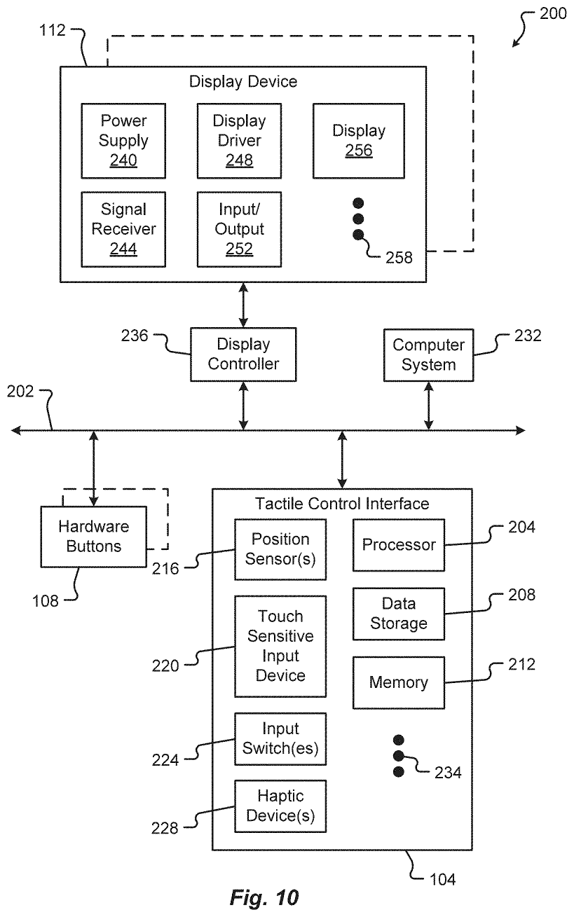

FIG. 10 is a block diagram of the hardware of a user interface system 200 in accordance with embodiments of the present disclosure. As described above, the user interface system 200 may include one or more display devices 112 that are configured to selectively activate pixels and/or display elements to render one or more user interface windows, indicators, icons, characters, etc. In one embodiment, the display device 112 may be a liquid crystal display (LCD), a light-emitting diode (LED) display, electroluminescent display (ELD), organic LED (OLED) display, and/or some other two-dimensional and/or three-dimensional display device. In some embodiments, the display device 112 may extends along a length of a vehicle console or dash. The display device 112 may be configured to render information in one or more discrete areas of the display 256. In any event, the display device 112 may include a power supply 240, a signal receiver 244, a display driver 248, at least one input/output port 252, a display 256, and/or more 258.

One or more display controllers 236 may be included for controlling the operation of the display device 112, including input (e.g., user interface device input) and output (display) functions. In some embodiments, the functions of the display controller 236 may be incorporated into other components, such as a processor or computer system 232.

The computer system 232 may include a processor or controller for executing application programming and/or instructions. In accordance with at least some embodiments of the present disclosure, the computer system 232 may include multiple processor cores, and/or implement multiple virtual processors. In one embodiment, the computer system 232 may include multiple physical processors. For instance, the computer system 232 may comprise a specially configured application specific integrated circuit (ASIC) or other integrated circuit, a digital signal processor, a controller, a hardwired electronic or logic circuit, a programmable logic device or gate array, a special purpose computer, and/or the like. The computer system 232 may function to run programming code or instructions implementing various functions of the user interface system 200.

One or more hardware buttons 108 may be associated with the user interface system 200 and/or the jog dial user interface device 104. The hardware buttons 108 may be configured as switches, buttons, dials, touchpads (e.g., capacitive and/or resistive touch-sensitive pads), and/or some other control device for use in connection with certain control operations of the computer system 232 and/or the jog dial user interface device 104.

Communications between various components of the user interface system 200 may be carried by one or more buses 202. In some embodiments, power may be supplied to the components of the user interface system 200 from a power source and/or power control module. The power control module may include, but is in no way limited to, a battery, an AC-to-DC converter, power control logic, and/or ports for interconnecting the jog dial user interface device 104, the display device 112, and/or other components of the user interface system 200 to a source of power.

The jog dial user interface device 104 may include one or more processors 204, data storage 208, memory 212, position sensor(s) 216, touch sensitive input device 220, input switch(es) 224, haptic device(s) 228, and/or other components 232. As described herein, input provided by the jog dial user interface device 104 may be communicated to the computer system 232 and/or the display device 112 via one or more bus 202.

The processor 204 may comprise a programmable processor or controller for executing application programming or instructions associated with the jog dial user interface device 104. In some embodiments, the processor 204 may include multiple processor cores, and/or implement multiple virtual processors. In one embodiment, the processor 204 may include multiple physical processors. For instance, the processor 204 may comprise a specially configured application specific integrated circuit (ASIC) or other integrated circuit, a digital signal processor, a controller, a hardwired electronic or logic circuit, a programmable logic device or gate array, a special purpose computer, or the like. In any event, the processor 204 may function to run programming code or instructions implementing various functions of the jog dial user interface device 104 and/or the user interface system 200.

The jog dial user interface device 104 may also include a data storage 208 and/or memory 212 for use in connection with the execution of application programming or instructions by the processor 204, and/or for the temporary or long-term storage of program instructions and/or data. By way of example, the data storage 208 and/or the memory 212 may comprise RAM, DRAM, SDRAM, or other solid state memory device. In one embodiment, the data storage 208 may comprise a hard disk drive or other random access memory that is separate from the memory 212.

In some embodiments, the jog dial user interface device 104 may include one or more position sensor(s) 216. The position sensor(s) 216 may provide a signal indicating a position of a code wheel, encoder plate, and/or rotary dial of the jog dial user interface device 104. In one embodiment, this signal and position information can be provided as an input, for example to a user interface application running via the processor 204 and/or the computer system 232, to determine an application operating mode, an output for display by the display device 112 (e.g., a position of a user interface element, indicator, pointer, etc., rendered by the display 256 of the display device 112), a speed or other characteristic of the output for display by the display device 112, and/or other jog dial user interface device 104 operations. The position sensor(s) 216 may include one or more of a multiple position switch, an optical switch, an optical sensor (e.g., encoder, etc.), a magnetic sensor, a magnetic switch, a potentiometer, and/or other device capable of providing a signal indicating a number of multiple relative positions of the rotary dial from a rotational origin or reference point.

The jog dial user interface device 104 may include at least one touch sensitive input device 220. In some embodiments, the touch sensitive input device 220 may be disposed inside a rotary dial and may be rotationally fixed (e.g., relative to the rotary dial etc.). The touch sensitive input device 220 may include a physical structure, or a touchpad substrate, that enables the user to interact with the computer system 232 by touching areas on the touchpad and provide information to a user through the display device 112. The touch sensitive input device 220 may sense user contact in a number of different ways, such as by a change in an electrical parameter (e.g., resistance or capacitance), acoustic wave variations, infrared radiation proximity detection, light variation detection, and/or the like. In a resistive touchpad, for example, normally separated conductive and resistive metallic layers in the substrate pass an electrical current. When a user touches the touchpad, the two layers may make contact in the contacted location, whereby a change in electrical field is noted and the coordinates of the contacted location is calculated. In a capacitive touchpad, a capacitive layer may store electrical charge, which is then discharged to the user upon contact with the touchpad, causing a decrease in the charge of the capacitive layer. The decrease may be measured (e.g., via the processor 204, etc.), and the contacted location coordinates determined. In a surface acoustic wave touchpad, an acoustic wave is transmitted through the touchpad, and the acoustic wave may be disturbed by user contact/interaction. A receiving transducer can detect this user contact/interaction instance and then determine the contacted location coordinates associated with the contact/interaction.

Similar to the hardware buttons 108, the jog dial user interface device 104 may include one or more integrated input switch(es) 224. These input switch(es) 224 may receive an actuation or selection input provided by a user at the one or more components of the jog dial user interface device 104. In one embodiment, a user may press and physically displace (e.g., some distance) the rotary dial and/or touchpad along a common selection axis (e.g., the axis of rotation for the rotary dial, etc.) to provide a selection input. This input may be received via a switch, button, optical sensor, or other device that is operatively coupled with the rotary dial and/or touchpad. In some embodiments, the rotary dial may be physically actuated separately and apart from physically actuating the touchpad, and/or vice versa. In this instance, separate input switch(es) 224 may be associated with each of the rotary dial and the touchpad (e.g., providing unique selection input for each device component).

In some embodiments, the jog dial user interface device 104 may include one or more haptic device(s) 228. Haptic devices 228 can include any device that is configured to convert an electrical signal into a mechanical movement or physical feedback to a user of the jog dial user interface device 104. Examples of the haptic device(s) 228 may include, but are in no way limited to, vibrating motors, tactile transducers, eccentric movement motors, magnetically-actuated vibration devices, solenoids, vibrating motor disks, coin-cell vibration motors, piezoelectric transducers, surface transducers, and/or the like. As described herein, the haptic device(s) 228 may be configured to provide feedback to a user of a position of the rotary dial, a selection, a display output, a speed of output, and/or the like. In some embodiments, the feedback may be accompanied by an audible output (e.g., a sound, tone, click, etc.) provided by the haptic device(s) 228. In one embodiment, the haptic device(s) 228 may operate in conjunction with a speaker and/or an amplifier that provides the audible output. The haptic device(s) 228 may be attached to the touch sensitive input device 220, or touchpad, touchpad support member, the center shaft, the jog dial, or other surface of the jog dial user interface device 104.

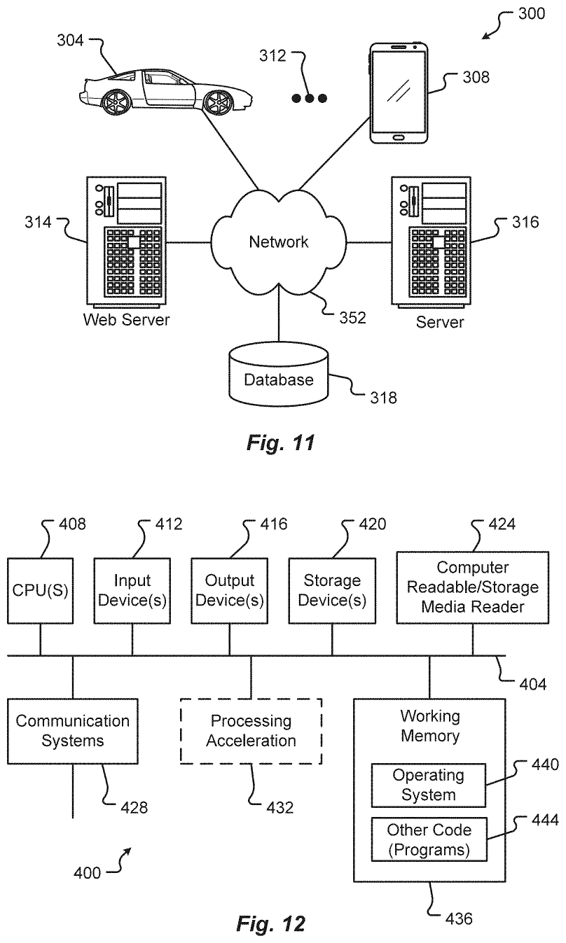

FIG. 11 illustrates a block diagram of a computing environment 300 that may function as the servers, user computers, computer system 232, or other systems provided and described herein. The computing environment 300 includes one or more user computers, or computing devices, such as a vehicle computing device 304, a communication device 308, and/or more 312. The computing devices 304, 308, 312 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 304, 308, 312 may also have any of a variety of applications, including for example, database client and/or server applications, and web browser applications. Alternatively, the computing devices 304, 308, 312 may be any other electronic device, such as a thin-client computer, Internet-enabled mobile telephone, and/or personal digital assistant, capable of communicating via a network 352 and/or displaying and navigating web pages or other types of electronic documents. Although the exemplary computing environment 300 is shown with two computing devices, any number of user computers or computing devices may be supported.

The computing environment 300 may also include one or more servers 314, 316. In this example, server 314 is shown as a web server and server 316 is shown as an application server. The web server 314, which may be used to process requests for web pages or other electronic documents from computing devices 304, 308, 312. The web server 314 can be running an operating system including any of those discussed above, as well as any commercially-available server operating systems. The web server 314 can also run a variety of server applications, including SIP (Session Initiation Protocol) servers, HTTP(s) servers, FTP servers, CGI servers, database servers, Java servers, and the like. In some instances, the web server 314 may publish operations available operations as one or more web services.

The computing environment 300 may also include one or more file and or/application servers 316, which can, in addition to an operating system, include one or more applications accessible by a client running on one or more of the computing devices 304, 308, 312. The server(s) 314 and/or 316 may be one or more general purpose computers capable of executing programs or scripts in response to the computing devices 304, 308, 312. As one example, the server 314, 316 may execute one or more web applications. The web application may be implemented as one or more scripts or programs written in any programming language, such as Java™, C, C #®, or C++, and/or any scripting language, such as Perl, Python, or TCL, as well as combinations of any programming/scripting languages. The application server(s) 316 may also include database servers, including without limitation those commercially available from Oracle®, Microsoft®, Sybase®, IBM® and the like, which can process requests from database clients running on a computing device 304, 308, 312.

The web pages created by the server 314 and/or 316 may be forwarded to a computing device 304, 308, 312 via a web (file) server 314, 316. Similarly, the web server 314 may be able to receive web page requests, web services invocations, and/or input data from a computing device 304, 308, 312 (e.g., a user computer, etc.) and can forward the web page requests and/or input data to the web (application) server 316. In further embodiments, the server 316 may function as a file server. Although for ease of description, FIG. 3 illustrates a separate web server 314 and file/application server 316, those skilled in the art will recognize that the functions described with respect to servers 314, 316 may be performed by a single server and/or a plurality of specialized servers, depending on implementation-specific needs and parameters. The computer systems 304, 308, 312, web (file) server 314 and/or web (application) server 316 may function as the system, devices, or components described in FIGS. 1-3.

The computing environment 300 may also include a database 318. The database 318 may reside in a variety of locations. By way of example, database 318 may reside on a storage medium local to (and/or resident in) one or more of the computers 304, 308, 312, 314, 316. Alternatively, it may be remote from any or all of the computers 304, 308, 312, 314, 316, and in communication (e.g., via the network 352) with one or more of these. The database 318 may reside in a storage-area network (“SAN”) familiar to those skilled in the art. Similarly, any necessary files for performing the functions attributed to the computers 304, 308, 312, 314, 316 may be stored locally on the respective computer and/or remotely, as appropriate. The database 318 may be a relational database, such as Oracle 20i®, that is adapted to store, update, and retrieve data in response to SQL-formatted commands.

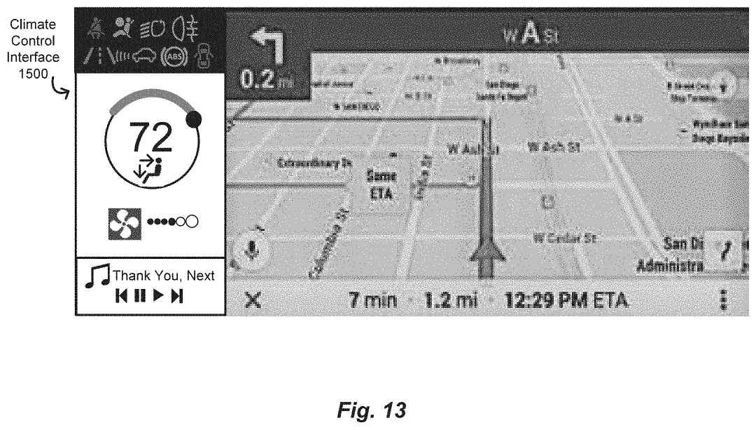

FIG. 12 illustrates one embodiment of a computer system 400 upon which the servers, user computers, computing devices, computer system 232, or other systems or components described above may be deployed or executed. The computer system 400 is shown comprising hardware elements that may be electrically coupled via a bus 404. The hardware elements may include one or more central processing units (CPUs) 408; one or more input devices 412 (e.g., a mouse, a keyboard, etc.); and one or more output devices 416 (e.g., a display device, a printer, etc.). The computer system 400 may also include one or more storage devices 420. By way of example, storage device(s) 420 may be disk drives, optical storage devices, solid-state storage devices such as a random access memory (“RAM”) and/or a read-only memory (“ROM”), which can be programmable, flash-updateable and/or the like.

The computer system 400 may additionally include a computer-readable storage media reader 424, a communications system 428 (e.g., a modem, a network card (wireless or wired), an infra-red communication device, etc.), and working memory 436, which may include RAM and ROM devices as described above. The computer system 400 may also include a processing acceleration unit 432, which can include a DSP, a special-purpose processor, and/or the like.

The computer-readable storage media reader 424 can further be connected to a computer-readable storage medium, together (and, optionally, in combination with storage device(s) 420) comprehensively representing remote, local, fixed, and/or removable storage devices plus storage media for temporarily and/or more permanently containing computer-readable information. The communications system 428 may permit data to be exchanged with a network and/or any other computer described above with respect to the computer environments described herein. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 400 may also comprise software elements, shown as being currently located within a working memory 436, including an operating system 440 and/or other code 444. It should be appreciated that alternate embodiments of a computer system 400 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 204, 408 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

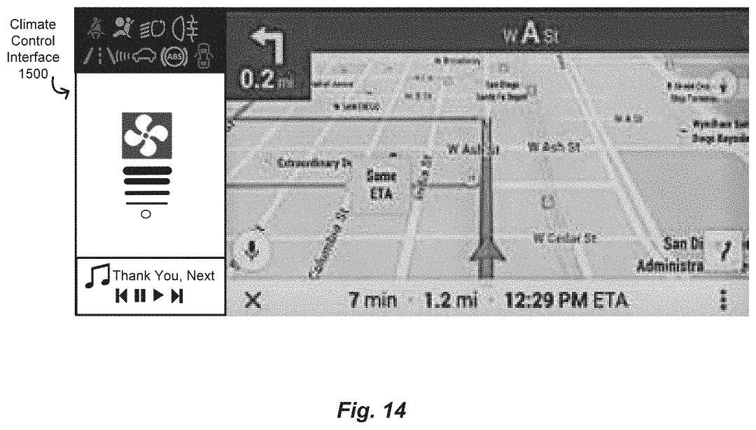

FIG. 13 illustrates an example of climate control interface 1500. Climate control interface may be displayed on display 112. As illustrated, in other sections, the display may display map/navigation information, and audio information, such as the song time and functions to control audio output. What is displayed in the climate control interface 1500 section may change based on user input. In some embodiments, a user may select/open a sub-menu, such as fan speed, which is then displayed in climate control interface 1500 as illustrated in FIG. 14. For example, depressing the dial may invoke the airflow direction menu (i.e., mode) and rotating the dial while within this sub-menu allows the user to adjust the fan speed (high, low, max, min, etc.) using the tactile control device, the fan speed is adjusted based on the direction of rotation. In another example, the user may tilt the dial and open a mode sub-menu, within this sub-menu, rotating the dial will select various modes, a click may select the highlighted mode.

FIG. 15 illustrates various states 1600A-D of climate control interface 1500. For example, rotating the dial may invoke the temperature menu, which may be displayed as a visual temperature indicator in the climate control interface. As the user rotates the dial, the temperature may either increase or decrease based on the direction of the rotation. Climate control interface 1500 may show various HVAC settings/functions. For example, temperature indicator 1604, mode indicator 1608, and fan speed indicator 1612. Visual control indicators may include visual guides for user feedback regarding how the HVAC system is going to respond to a particular user input. For example, when a user rotates the dial, when the temperature function is selected, a representation of the resting set point may move along the temperature arc and/or temperature wheel, the user will see a temperature gradient created. In some embodiments, the temperature gradient will be represented by a color (e.g., red or blue). Additionally, if the newly selected temperature is the maximum value for either cooling or heating, the indicator may display the word “MAX,” which may replace the temperature number. The word “MAX” may be colored based on whether the temperature is maximum cooling (blue) or maximum heating (red).

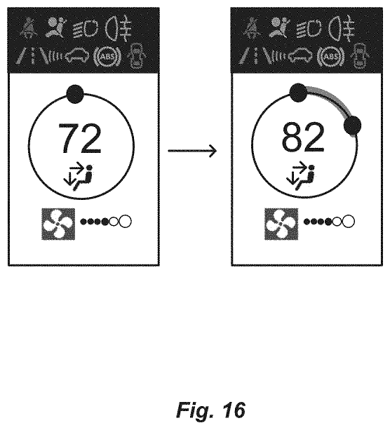

As illustrated in FIG. 16. the current temperature is set to 72 degrees. The user via the tactile control device adjusts the temperature to 82 degrees. The indicator moves along the temperature arc circumference until it reaches the selected set point. The arc distance between the current temperature and the new set point will be shaded or colored.

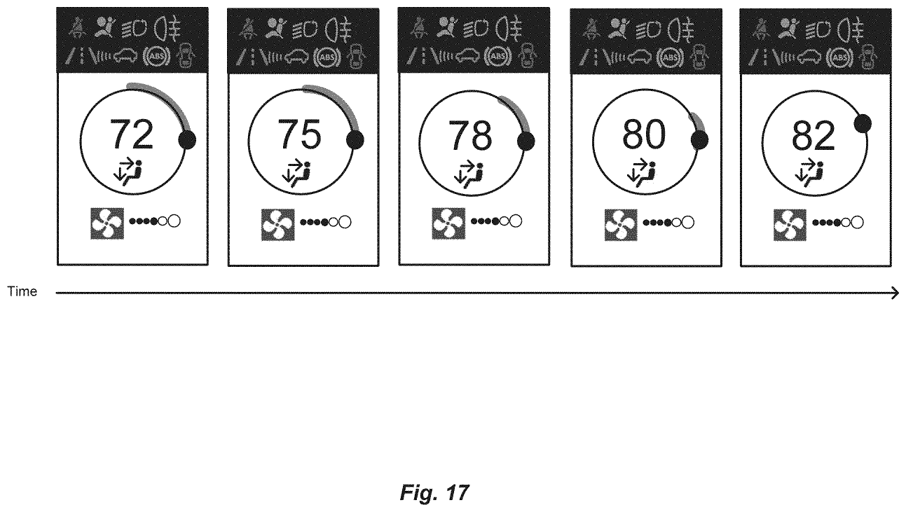

In some embodiments, the arc/gradient is animated as decreases as the current temperature reaches the set temperature. FIG. 17 represents the various states of the climate control interface as the temperature indicator animates the temperature adjustment. For example, as the current/actual temperature reaches the set temperature, the arc may illustratively decrease, until it disappears. In some embodiments, the indicator may also indicate the amount of time until the set temperature is reached.

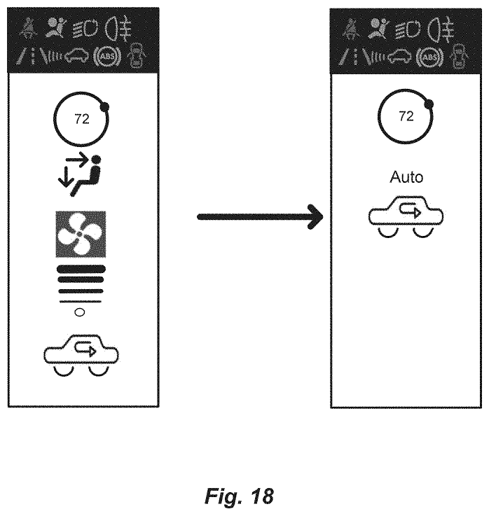

FIG. 18 illustrates automode control. In some embodiments, the HVAC system includes an “automode” that can be engaged with a separate button or from the climate control interface using the tactile control device. Automode uses a unique method to determine the user's preferred HAVC settings. With one button/selection the user can adjust multiple HVAC settings, such as preferred temperature, fan speed, and/or airflow direction. The HVAC system may consider various factors, including but not limited to, outside temperature, internal temperature, previous settings, location, warmth from sunshine, etc., to adjust various settings to achieve the desired temperature for the user. In some embodiments, when automode is engaged, the climate control interface will remove some options (e.g., fan speed and mode).

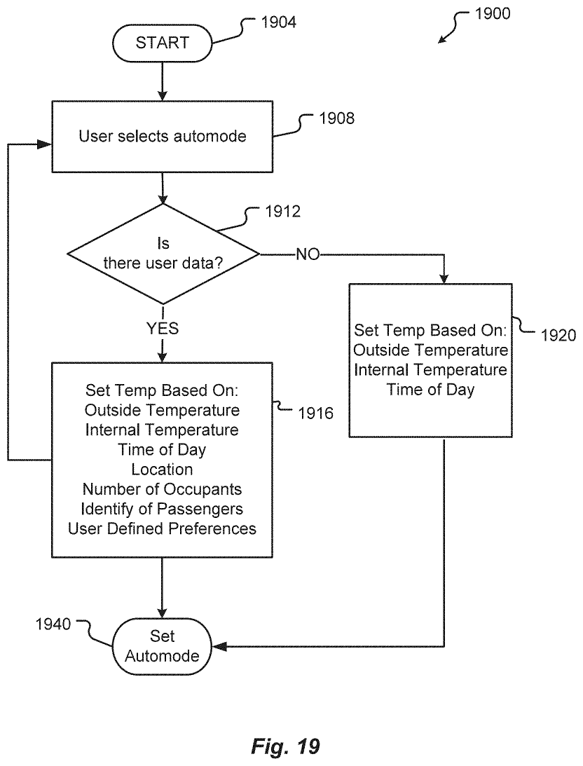

FIG. 19 illustrates is a flow diagram of a method 1900 for engaging/setting automode in a vehicle's HVAC system in accordance with embodiments of the present disclosure. In some embodiments, automode is engaged via a hardware button. While a general order for the steps of the method 1900 is shown in FIG. 19, the method 1900 can include more or fewer steps or can arrange the order of the steps differently than those shown in FIG. 19. Generally, the method 1900 starts with a start operation 1904 and ends with a set automode operation 1940. The method 1900 can be executed as a set of computer-executable instructions executed by a computer system (e.g., computer system 232, processor 204, etc.) and encoded or stored on a computer readable medium (e.g., data storage 208, memory 212, etc.). Hereinafter, the method 1900 shall be explained with reference to the systems, components, assemblies, devices, user interfaces, environments, software, etc. described in conjunction with FIGS. 1-18.

The method 1900 begins at step 1904 and proceeds by detecting that a user has engaged automode (step 1908). Next, the method 1900 determines if there is user data (step 1912). In some embodiments, a database may be queried for user data, such as the identity of the driver/passengers, driver/passenger HVAC preferences, etc. User data may comprise number of occupants, identity of occupants, and/or user defined preferences. If there is user data, the algorithm using the user data to intelligently set the HVAC system according the driver/passenger(s) preferences (step 1916). If there is no user data available, the automode algorithm may still use intelligence to set HVAC settings. In some embodiments, the automode algorithm may consider factors, such as outside temperature, internal temperature, time of day, location, and/or other factors—including combinations thereof.

The method 1200 may continue by determining a type of the visual objects displayed, or rendered, to the display device 112 (step 1216). In some cases, the visual objects may include objects of a type that can be navigated between or through. These types of objects may include, but are in no way limited to, menus, lists, grids, organized icons, arrays of images or icons, matrices, etc., and/or combinations thereof. Some visual objects may be of a type that cannot be navigated between or through. These types of objects may include, but are in no way limited to, single images, icons, ends of lists, etc., and/or combinations thereof.

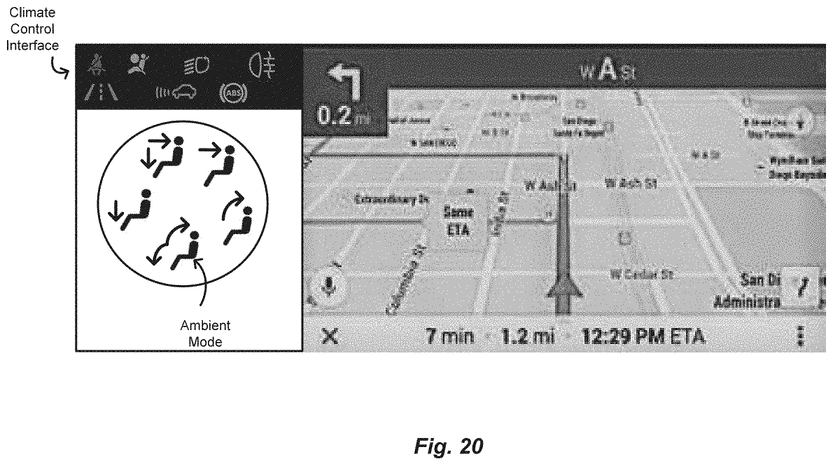

FIG. 20 illustrates an ambient mode HVAC setting. In some embodiments, the HVAC control assembly includes controls that allows the user to manipulate the airflow of registers, grills, vents, returns, louvers, etc. In some vehicles, the vents may be difficult to reach/adjust. The tactile control device may allow the user to control the flow/direction of air to the driver and/or passengers, by determining which and/or how many of the vents will be engaged. Additionally, the user may control the direction, for example, the vents may be titled upward or downward. In some embodiments, the user may manipulate the tactile dial (e.g., tilt) to engage a menu element corresponding to vent control. In some embodiments, the various modes may include “ambient” climate mode. In ambient climate mode, air enters the cabin of the vehicle from vents disposed substantially parallel to the windshield, and/or offset from an angle aiming at the operator/passenger(s). As such, ambient mode can provide a better climate control experience. In other words, the air is not aimed directly at the occupants of the vehicle.

Any of the steps, functions, and operations discussed herein can be performed continuously and automatically.

The exemplary systems and methods of this disclosure have been described in relation to user interface methods, devices, and systems. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a vehicle comprising an HVAC control assembly for navigating a menu associated with an HVAC system of the vehicle, the menu controlling operation of the HVAC system, the HVAC control assembly comprising: a climate control user interface to display one or more HVAC settings; a tactile control that moves in multiple directions to input a command to select an HVAC setting for the HVAC system of the vehicle, and a microprocessor, coupled with the climate control user interface, HVAC system, and tactile control, to receive the inputted command and generate a corresponding control signal to the HVAC system, wherein: the climate control user interface displays a cabin temperature setpoint for the HVAC system, the cabin temperature setpoint value being related to a current position of the tactile control, a current cabin temperature, and a difference between the displayed temperature setpoint and the current cabin temperature, and wherein: when a user moves the tactile control in a first direction, the displayed temperature setpoint moves in the first direction and changes value to provide a new displayed temperature setpoint and the difference is adjusted in response to movement in the first direction of the displayed temperature setpoint, and, when the user moves the tactile control in a different second direction, the displayed temperature setpoint moves in the second direction and the difference is adjusted in response to movement in the second direction of the displayed temperature setpoint.

Aspects of the above vehicle include the tactile control comprises a rotary dial supported by a longitudinal shaft, wherein the first direction is clockwise and the second direction is counterclockwise and wherein the microprocessor synchronizes rotational movement of the rotary dial with rotational movement of the temperature setpoint.

Aspects of the above vehicle include the microprocessor causes the climate control user interface to display the difference as a temperature gradient between the current cabin temperature and the currently displayed temperature setpoint, wherein, when the temperature setpoint moves to a first side of the current cabin temperature, the temperature gradient has a first appearance to the user indicating that the displayed temperature setpoint is cooler than the current cabin temperature and wherein, when the temperature setpoint moves to an opposing second side of the current cabin temperature, the temperature gradient has a different second appearance to the user indicating that the displayed temperature setpoint is warmer than the current cabin temperature. Aspects of the above vehicle include the temperature gradient is displayed as an arcuate band, wherein the first appearance is a first color and the second appearance is a different second color, and wherein the arcuate band occupies a portion of an arc, the arc having a same shape as a surface of the rotary dial.

Aspects of the above vehicle include the current cabin temperature and displayed temperature setpoint are displayed as discrete points on the arc and wherein the arcuate band has, as a first endpoint, the point corresponding to the current cabin temperature and has, as a second endpoint, the point corresponding to the displayed temperature setpoint. Aspects of the above vehicle include wherein the current cabin temperature is displayed as a point on the arc and as a number value positioned interiorly to the arc.

Aspects of the above vehicle include the tactile control comprises a rotary dial supported by a longitudinal shaft, wherein a movement of the rotary dial is associated with a temperature control, and the microprocessor detects the movement of the rotary dial and determines a new set point when a period of time at which the rotary dial rests at a selected position is at least a threshold time period and generates a corresponding control signal to the HVAC system to change the current cabin temperature to the selected temperature setpoint.

Aspects of the above vehicle include the climate control user interface further comprises a numerical indicator that represents the current temperature. Aspects of the above vehicle include wherein the climate control user interface further comprises a numerical indicator that represents the difference between the set point and the current temperature. Aspects of the above vehicle include wherein the climate control user interface further comprises a numerical indicator that represents the set point

Aspects of the above vehicle further comprising: a first button that activates/deactivates an air-conditioning system; a second button that activates/deactivates a re-circulation function; and a third button that activates an auto mode.

Embodiments include a vehicle comprising an HVAC control assembly for navigating a menu associated with an HVAC system of the vehicle, the menu controlling operation of the HVAC system, the HVAC assembly comprising: a climate control user interface to display one or more HVAC settings and receive user inputted HVAC control commands; and a microprocessor, coupled with the climate control user interface and HVAC control assembly, to receive the inputted control command and generate a corresponding control signal to the HVAC system, wherein the user can select to adjust a setpoint for a cabin temperature manually or automatically in an automode; and wherein, when the user selects the automode, the microprocessor automatically determines one or more settings of the HVAC system based on an outside temperature and a current cabin temperature and one or more of a time of day, day of week, a vehicle spatial location, and a number of currently sensed occupants of the vehicle and causes the HVAC control assembly to change the current cabin temperature to the determined temperature setpoint.

Aspects of the above vehicle include the one or more settings of the HVAC system comprise a temperature setpoint for the cabin and wherein the microprocessor, in the automode, automatically determines a temperature setpoint based on the outside temperature, current cabin temperature and plurality of the time of day, day of week, vehicle spatial location, and number of currently sensed occupants of the vehicle.

Aspects of the above vehicle include the one or more settings of the HVAC system comprise a speed and direction of airflow in the cabin and wherein the microprocessor, in the automode, automatically determines the temperature setpoint based on the outside temperature, current cabin temperature, time of day, day of week, vehicle spatial location, and number of currently sensed occupants of the vehicle.

Aspects of the above vehicle further comprising: a tactile control that moves in multiple directions to input a control command to select an HVAC setting for the HVAC system of the vehicle, wherein the tactile control comprises a rotary dial supported by a longitudinal shaft, the climate control user interface displays a cabin temperature setpoint for the HVAC system, the cabin temperature setpoint value being related to a current position of the rotary dial, a current cabin temperature, and a difference between the displayed temperature setpoint and current cabin temperature; and wherein, when a user moves the rotary dial in a first direction, the displayed temperature setpoint moves in the first direction and changes value to provide a new displayed temperature setpoint and the difference is adjusted in response to movement in the first direction of the displayed temperature setpoint and, when the user moves the rotary dial in a different second direction, the displayed temperature setpoint moves in the second direction and the difference is adjusted in response to movement in the second direction of the displayed temperature setpoint.

Embodiments a vehicle comprising a Heating, Ventilation, and Air-Conditioning (HVAC) control assembly for navigating a menu associated with an HVAC system of the vehicle, the menu controlling operation of the HVAC system, the HVAC assembly comprising: a climate control user interface to display one or more HVAC settings; a control that moves in multiple directions to input a control command to select an HVAC airflow setting for the HVAC system of the vehicle; and a microprocessor, coupled with the climate control user interface, HVAC system, and tactile control, to receive the inputted control command and generate a corresponding control signal to the HVAC system, wherein: the climate control user interface displays a plurality of user selectable airflow modes, each of the user selectable airflow modes indicating an airflow direction relative to a seating position of one or more vehicle occupants, and wherein, in response to user selection of an airflow mode, the microprocessor automatically a setting of one or more air exhausts to provide the user selected airflow corresponding to the user selected airflow mode.

Aspects of the above vehicle include in a first airflow mode, the microprocessor causes air external to the vehicle to enter the cabin from one or more vents of the air exhausts, the one or more vents being oriented substantially parallel to a windshield of the vehicle and/or offset from an angle aiming at a vehicle occupant.

Aspects of the above vehicle include while scrolling through the plurality of user selectable airflow modes, a spatial orientation of each of the one or more air exhausts is changed as defined by the corresponding airflow mode to provide the user with a preview of the airflow provided by the corresponding airflow mode.

Aspects of the above vehicle wherein the climate control user interface displays a cabin temperature setpoint for the HVAC system, the cabin temperature setpoint value being related to a current position of the tactile control, a current cabin temperature, and a difference between the displayed temperature setpoint and current cabin temperature; and wherein, when a user moves the tactile control in a first direction, the displayed temperature setpoint moves in the first direction and changes value to provide a new displayed temperature setpoint and the difference is adjusted in response to movement in the first direction of the displayed temperature setpoint and, when the user moves the tactile control in a different second direction, the displayed temperature setpoint moves in the second direction and the difference is adjusted in response to movement in the second direction of the displayed temperature setpoint.

Aspects of the above vehicle wherein the climate control user interface displays a climate control menu comprising various climate control settings, receives a selection of an airflow sub-menu and displaying the airflow sub-menu, wherein the airflow sub-menu comprises icons representing various airflow modes, and wherein motion of a rotary dial is synchronized to the various airflow modes and as a user rotates the rotary dial, another display adjacent to the airflow sub-menu displays configurations of vents corresponding to a highlighted airflow mode, receives a selection of an airflow mode, and configures the vents according to the selected airflow mode.

Any one or more of the aspects/embodiments as substantially disclosed herein.

Any one or more of the aspects/embodiments as substantially disclosed herein optionally in combination with any one or more other aspects/embodiments as substantially disclosed herein.

One or more means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A vehicle comprising a Heating, Ventilation, and Air-Conditioning (HVAC) control assembly for navigating a menu associated with an HVAC system of the vehicle, the menu controlling operation of the HVAC system, the HVAC assembly comprising:
a climate control user interface to display one or more HVAC settings;
a tactile control that moves in multiple directions to input a control command to select an HVAC setting for the HVAC system of the vehicle; and
a microprocessor, coupled with the climate control user interface, HVAC system, and tactile control, to receive the inputted control command and generate a corresponding control signal to the HVAC system, wherein:
the climate control user interface displays a cabin temperature setpoint for the HVAC system, a value of the cabin temperature setpoint being related to a current position of the tactile control, a current cabin temperature, and a difference between the displayed temperature setpoint and current cabin temperature; and
wherein, when a user moves the tactile control in a first direction, the displayed temperature setpoint moves in the first direction and changes value to provide a new displayed temperature setpoint and the difference is adjusted in response to movement in the first direction of the displayed temperature setpoint and, when the user moves the tactile control in a different second direction, the displayed temperature setpoint moves in the second direction and the difference is adjusted in response to movement in the second direction of the displayed temperature setpoint.

2. The vehicle of claim 1, wherein the tactile control comprises a rotary dial supported by a longitudinal shaft, wherein the first direction is clockwise and the second direction is counterclockwise and wherein the microprocessor synchronizes rotational movement of the rotary dial with rotational movement of the temperature setpoint.

3. The vehicle of claim 2, wherein the microprocessor causes the climate control user interface to display the difference as a temperature gradient between the current cabin temperature and the currently displayed temperature setpoint, wherein, when the temperature setpoint moves to a first side of the current cabin temperature, the temperature gradient has a first appearance to the user indicating that the displayed temperature setpoint is cooler than the current cabin temperature and wherein, when the temperature setpoint moves to an opposing second side of the current cabin temperature, the temperature gradient has a different second appearance to the user indicating that the displayed temperature setpoint is warmer than the current cabin temperature.

4. The vehicle of claim 3, wherein the temperature gradient is displayed as an arcuate band, wherein the first appearance is a first color and the second appearance is a different second color, and wherein the arcuate band occupies a portion of an arc, the arc having a same shape as a surface of the rotary dial.

5. The vehicle of claim 4, wherein the current cabin temperature and displayed temperature setpoint are displayed as discrete points on the arc and wherein the arcuate band has, as a first endpoint, the point corresponding to the current cabin temperature and has, as a second endpoint, the point corresponding to the displayed temperature setpoint.

6. The vehicle of claim 5, wherein the current cabin temperature is displayed as a point on the arc and as a number value positioned interiorly to the arc.

7. The vehicle of claim 1, wherein the tactile control comprises a rotary dial supported by a longitudinal shaft, wherein a movement of the rotary dial is associated with a temperature control, and the microprocessor detects the movement of the rotary dial and determines a new set point when a period of time at which the rotary dial rests at a selected position is at least a threshold time period and generates a corresponding control signal to the HVAC system to change the current cabin temperature to the selected temperature setpoint.

8. The vehicle of claim 1, wherein the climate control user interface further comprises a numerical indicator that represents the current temperature.

9. The vehicle of claim 1, wherein the climate control user interface further comprises a numerical indicator that represents the difference between the set point and the current temperature.

10. The vehicle of claim 1, wherein the climate control user interface further comprises a numerical indicator that represents the set point.

11. The vehicle of claim 1, further comprising:
a first button that activates/deactivates an air-conditioning system;
a second button that activates/deactivates a re-circulation function; and
a third button that activates an auto mode.

12. A vehicle comprising a Heating, Ventilation, and Air-Conditioning (HVAC) control assembly for navigating a menu associated with an HVAC system of the vehicle, the menu controlling operation of the HVAC system, the HVAC assembly comprising:
a climate control user interface to display one or more HVAC settings and receive user inputted HVAC control commands; and
a microprocessor, coupled with the climate control user interface and HVAC control assembly, to receive the inputted control command and generate a corresponding control signal to the HVAC system, wherein the user can select to adjust a setpoint for a cabin temperature manually in a manual mode or automatically in an automode; and
wherein, when the user selects the automode, the microprocessor automatically determines one or more settings of the HVAC system based on an outside temperature and a current cabin temperature and one or more of a time of day, day of week, a vehicle spatial location, and a number of currently sensed occupants of the vehicle and causes the HVAC control assembly to change the current cabin temperature to the determined temperature setpoint.

13. The vehicle of claim 12, wherein the one or more settings of the HVAC system comprise a temperature setpoint for the cabin and wherein the microprocessor, in the automode, automatically determines a temperature setpoint based on the outside temperature, current cabin temperature and plurality of the time of day, day of week, vehicle spatial location, and number of currently sensed occupants of the vehicle.

14. The vehicle of claim 12, wherein the one or more settings of the HVAC system comprise a speed and direction of airflow in the cabin and wherein the microprocessor, in the automode, automatically determines the temperature setpoint based on the outside temperature, current cabin temperature, time of day, day of week, vehicle spatial location, and number of currently sensed occupants of the vehicle.

15. The vehicle of claim 12, further comprising:
a tactile control that moves in multiple directions to input a control command to select an HVAC setting for the HVAC system of the vehicle, wherein the tactile control comprises a rotary dial supported by a longitudinal shaft, the climate control user interface displays a cabin temperature setpoint for the HVAC system, the cabin temperature setpoint value being related to a current position of the rotary dial, a current cabin temperature, and a difference between the displayed temperature setpoint and current cabin temperature; and
wherein, when a user moves the rotary dial in a first direction, the displayed temperature setpoint moves in the first direction and changes value to provide a new displayed temperature setpoint and the difference is adjusted in response to movement in the first direction of the displayed temperature setpoint and, when the user moves the rotary dial in a different second direction, the displayed temperature setpoint moves in the second direction and the difference is adjusted in response to movement in the second direction of the displayed temperature setpoint.

16. A vehicle comprising a Heating, Ventilation, and Air-Conditioning (HVAC) control assembly for navigating a menu associated with an HVAC system of the vehicle, the menu controlling operation of the HVAC system, the HVAC assembly comprising:
a climate control user interface to display one or more HVAC settings;
a control that moves in multiple directions to input a control command to select an HVAC airflow setting for the HVAC system of the vehicle; and
a microprocessor, coupled with the climate control user interface, HVAC system, and tactile control, to receive the inputted control command and generate a corresponding control signal to the HVAC system, wherein:
the climate control user interface displays a plurality of user selectable airflow modes, each of the user selectable airflow modes indicating an airflow direction relative to a seating position of one or more vehicle occupants, and wherein, in response to user selection of an airflow mode, the microprocessor automatically alters a setting of one or more air exhausts to provide the user selected airflow corresponding to the user selected airflow mode.

17. The vehicle of claim 16, wherein, in a first airflow mode, the microprocessor causes air external to the vehicle to enter the cabin from one or more vents of the air exhausts, the one or more vents being oriented substantially parallel to a windshield of the vehicle and/or offset from an angle aiming at a vehicle occupant.

18. The vehicle of claim 16, wherein, while scrolling through the plurality of user selectable airflow modes, a spatial orientation of each of the one or more air exhausts is changed as defined by the corresponding airflow mode to provide the user with a preview of the airflow provided by the corresponding airflow mode.

19. The vehicle of claim 16, wherein the climate control user interface displays a cabin temperature setpoint for the HVAC system, the cabin temperature setpoint value being related to a current position of the tactile control, a current cabin temperature, and a difference between the displayed temperature setpoint and current cabin temperature; and
wherein, when a user moves the tactile control in a first direction, the displayed temperature setpoint moves in the first direction and changes value to provide a new displayed temperature setpoint and the difference is adjusted in response to movement in the first direction of the displayed temperature setpoint and, when the user moves the tactile control in a different second direction, the displayed temperature setpoint moves in the second direction and the difference is adjusted in response to movement in the second direction of the displayed temperature setpoint.

20. The vehicle of claim 16, wherein the climate control user interface displays a climate control menu comprising various climate control settings, receives a selection of an airflow sub-menu and displaying the airflow sub-menu, wherein the airflow sub-menu comprises icons representing various airflow modes, and wherein motion of a rotary dial is synchronized to the various airflow modes and as a user rotates the rotary dial, another display adjacent to the airflow sub-menu displays configurations of vents corresponding to a highlighted airflow mode, receives a selection of an airflow mode, and configures the vents according to the selected airflow mode.
